(19) United States
(12) Patent Application Publication
(10) Pub. No.: US 2012/0105136 A1
(43) Pub. Date: May 3, 2012

(54) FUSE LINK SYSTEM FOR DISPOSABLE COMPONENT

(75) Inventors: J. Michael Fausset, Lafayette, IN (US); Michael Sturdevant, Concord Twp., OH (US); Robert Schindler, Euclid, OH (US); Michael Terry, Akron, OH (US)

(73) Assignee: THERMALTHERAPEUTIC SYSTEMS, INC., Pittsburgh, PA (US)

(21) Appl. No.: 12/913,167

(22) Filed: Oct. 27, 2010

(51) Int. Cl. H01H 37/02

(52) U.S. Cl. 327/525

(57) ABSTRACT

A fuse system for use with a disposable component of a device may include a disposable component having at least a first lockout circuit and a second lockout circuit. The first lockout circuit may include a first fuse link, and the second lockout circuit may include a second fuse link. The fuse system may include a computing device in communication with the first lockout circuit and the second lockout circuit, and a computer-readable storage medium in communication with the computing device. The computer-readable storage medium may include one or more programming instructions for deactivating the first fuse link at a first time, and deactivating the second fuse link at a second time.

### CROSS REFERENCE TO RELATED APPLICATIONS

This application is related to U.S. patent application Ser. No. 12/054,013, filed Mar. 24, 2008, and U.S. patent application Ser. No. ______ (Attorney Docket No. 132326.00401), filed ______, the entireties of which are hereby incorporated by reference.

Not Applicable

### BACKGROUND

Typical disposable components, such as components of medical devices, include single-use connectors and/or fuses to ensure that the disposable components are used only once. However, certain actions other than device use, such as unexpected power outages and user adjustments of the disposable component, can trigger the fuse. As such, the disposable set is rendered unusable, and a new disposable set must be installed. This is neither cost-efficient nor time-efficient for a user.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

In an embodiment, a fuse system for use with a disposable component of a device may include a disposable component having at least a first lockout circuit and a second lockout circuit. The first lockout circuit may include a first fuse link, and the second lockout circuit may include a second fuse link. The fuse system may include a computing device in communication with the first lockout circuit and the second lockout circuit, and a computer-readable storage medium in communication with the computing device. The computer-readable storage medium may include one or more programming instructions for deactivating the first fuse link at a first time, and deactivating the second fuse link at a second time.

In an embodiment, a fuse system may include a disposable component configured to be used with a medical device. The disposable component may include at least a first lockout circuit and a second lockout circuit. The first lockout circuit may include a first fuse link, and the second lockout circuit may include a second fuse link. The fuse system may include a computing device in communication with the first lockout circuit and the second lockout circuit, and a computer-readable storage medium in communication with the computing device. The computer-readable storage medium may include one or more programming instructions for deactivating the first fuse link at a first time, and deactivating the second fuse at a second time. The second time may be subsequent to the first time.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 depicts an exemplary fuse link system according to an embodiment.

FIG. 2 illustrates an exemplary lockout circuit according to an embodiment.

FIG. 3 illustrates an exemplary method of deactivating fuse links according to an embodiment.

### DETAILED DESCRIPTION

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art.

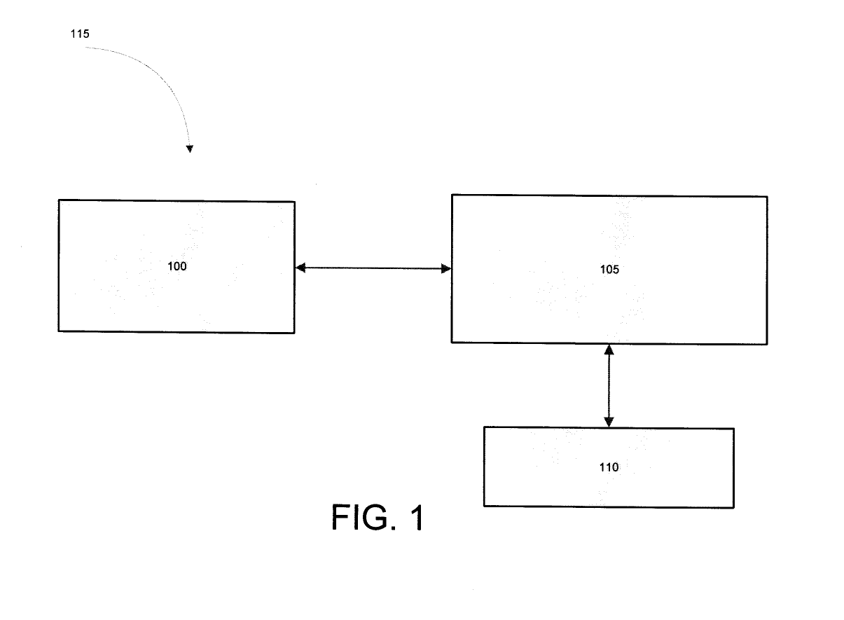

FIG. 1 illustrates an exemplary fuse link system according to an embodiment. As illustrated by FIG. 1, a fuse link system 115 may include a disposable component 100, a computing device 105 and/or a computer-readable storage medium. In an embodiment, the computing device 105 may be in communication with the disposable component 100 and/or the computer-readable storage medium 110. In an embodiment, the computer-readable storage medium 110 may include one or more programming instructions for the computing device 105.

In an embodiment, a disposable component may be a single use consumable that may be used as part of a device or apparatus. For example, exemplary disposable components 100 used in the medical field may include tubing, reservoir cartridges for hyperthermia apparatuses, needles, syringes, fluid collectors, endoscopes, probes, surgical instruments, medical instruments and/or the like. Additional exemplary disposable components 100 may include vacuum cleaner bags, furnace filters, ink cartridges and/or other disposable components of an electrical or electronic device.

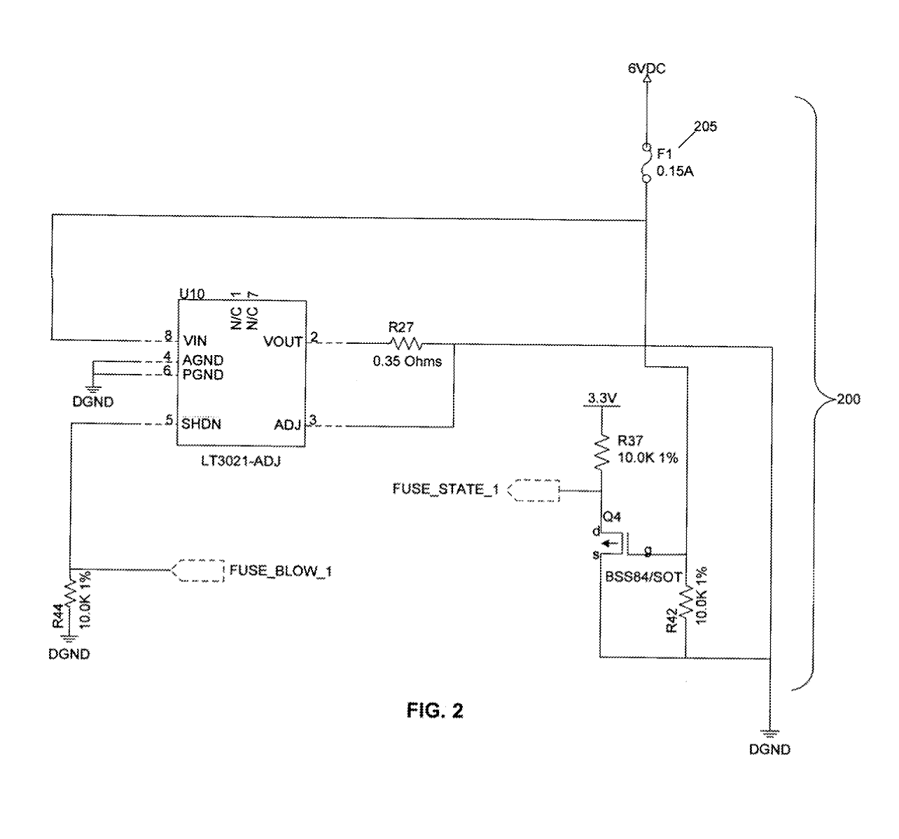

In an embodiment, a disposable component 100 may include two or more lockout circuits, resistor circuits and/or the like. For example, FIG. 2 illustrates an exemplary lockout circuit 200 that may be used according to an embodiment. In an embodiment, a lockout circuit 200 may be located in a disposable component 100 near an inlet, an outlet or other connector of the disposable component. In an embodiment, a lockout circuit may be located in additional and/or alternate locations on a disposable component 100.

In an embodiment, a lockout circuit 200 may include one or more fuse links 205. In an embodiment, the fuse links 205 may be mechanical, electrical and/or the like. In an embodiment, a first mechanical fuse link of a disposable component 100 may be broken during installation of the disposable component. A second mechanical fuse link of a disposable component 100 may be broken when the disposable component is disconnected from its associated device. A disposable component 100 may be operable so long as at least one of the fuses are intact. If both fuses are broken, a disposable component 100 may not function or operate.

In an embodiment, an electrical fuse link may be controllable by a computing device 105. In an embodiment, the computing device 105 may open or otherwise deactivate the fuse links at certain times to prevent unauthorized use of and/or re-use of a disposable component 100.

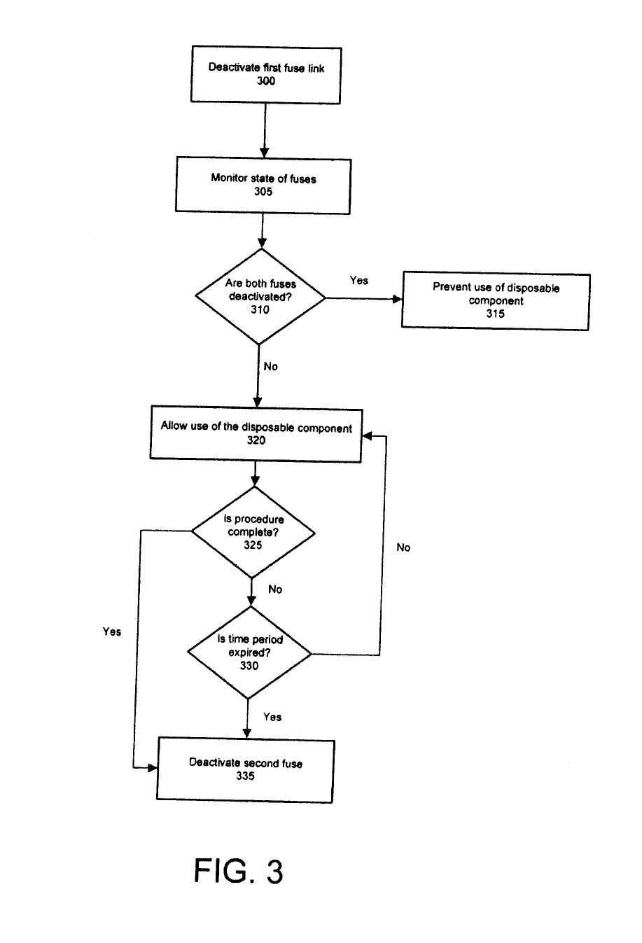

FIG. 3 illustrates an exemplary method of deactivating fuse links according to an embodiment. As illustrated by FIG. 3, a first fuse link may be deactivated 300 by the computer 105 when a disposable component 100 is powered on. Alternatively, a first fuse link may be deactivated at a certain time after a disposable component 100 and/or a device of which it is a part, is powered on. For example, a first fuse link in a set of medical tubing may be deactivated one minute after a pump is powered on. Additional and/or alternate time periods may be used within the scope of this disclosure.

In an embodiment, the computer 105 may monitor 305 the state of the fuses. If both fuse links are deactivated 310, the computer 105 may prevent 315 use of the disposable component 100. In an embodiment, the computer 105 may prevent use of the disposable component 100 by powering off the device or apparatus of which it is a part. In an embodiment, the computer 105 may display a notification to a user that the disposable component 100 is no longer operable.

In an embodiment, the computer 105 may allow 320 use of the disposable component 100 if both fuse links are intact or if one of the fuse links is intact. For example, the computer 105 may allow 320 use of the disposable component 100 if the first and second fuse links are intact or if the second fuse link is intact. As such, a user may connect and reconnect the disposable component 100 as many times as necessary during installation without risk of disabling the disposable component. In addition, a new disposable component 100 may not need to be installed if its device or apparatus experiences a power outage or if power is otherwise interrupted.

In an embodiment, the second fuse link may be deactivated 335 by the computer 105 when the disposable component 100 is finished being used 325. For example, the computer 105 may deactivate 335 a second fuse link when the device or apparatus is powered off. In an alternate embodiment, the computer 105 may receive notification from a user that use of a disposable component 100 is completed. For example, a user may push a button, select an icon or otherwise inform the computer 125 that use of the disposable component 100 has ended. At this time, the computer 125 may deactivate 335 the second fuse link. It is understood that the fuse links may be deactivated 335 at alternate times within the scope of this disclosure.

In an embodiment, the computer 105 may deactivate 335 the second fuse link after a certain time period has expired 330. For example, the computer 105 may deactivate 335 the second fuse link after a certain time period 330 from when the device or apparatus was powered on. For instance, the computer 105 may deactivate the second fuse link eight hours after the device or apparatus has been powered on. Alternatively, the computer 105 may deactivate 335 the second fuse link a certain time period after the first fuse link was deactivated.

In an embodiment, the computer may deactivate 335 the second fuse link if the computer 105 does not receive confirmation of that use of a disposable component 100 has ended within a certain time period. For instance, use of a disposable component may be scheduled to take five hours. If the computer 105 does not receive confirmation of completion of within one hour of the scheduled time of completion, the computer may deactivate 335 the second fuse link.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

What is claimed is:

1. A fuse system for use with a disposable component of a device, the fuse system comprising:
a disposable component comprising at least a first lockout circuit and a second lockout circuit, wherein the first lockout circuit comprises a first fuse link, wherein the second lockout circuit comprises a second fuse link;
a computing device in communication with the first lockout circuit and the second lockout circuit; and
a computer-readable storage medium in communication with the computing device, wherein the computer-readable storage medium comprises one or more programming instructions for:
deactivating the first fuse link at a first time, and
deactivating the second fuse link at a second time.

2. The fuse system of claim 1, wherein the one or more programming instructions for deactivating the first fuse link comprise one or more programming instructions for deactivating the first fuse link when the device is powered on.

3. The fuse system of claim 1, wherein the one or more programming instructions for deactivating the first fuse link comprise one or more programming instructions for deactivating the first fuse link a certain time period after the device has been powered on.

4. The fuse system of claim 1, wherein the one or more programming instructions comprise one or more programming instructions for:
in response to the first fuse link and the second fuse link being deactivated, preventing use of the disposable component by the device.

5. The fuse system of claim 1, wherein the one or more programming instructions comprise one or more programming instructions for allowing use of the disposable component by the device if both the first fuse link and the second fuse link are intact.

6. The fuse system of claim 1, wherein the one or more programming instructions comprise one or more programming instructions for allowing use of the disposable component by the device if only the second fuse link is intact.

7. The fuse system of claim 1, wherein the one or more programming instructions comprise one or more programming instructions for:
in response to use of the device being completed, deactivating the second fuse link.

8. The fuse system of claim 7, wherein the one or more programming instructions for determining whether use of the device is completed comprise one or more programming instructions for:
receiving confirmation that use of the device is completed from a user; and
in response to receiving confirmation, deactivating the second fuse link.

9. The fuse system of claim 1, wherein the one or more programming instructions comprise one or more programming instructions for:
in response to expiration of a period of time after the device was powered on, deactivating the second fuse link.

10. The fuse system of claim 1, wherein the one or more programming instructions comprise one or more programming instructions for:
in response to expiration of a period of time after deactivation of the first fuse link, deactivating the second fuse link.

11. A fuse system comprising:
a disposable component configured to be used with a medical device, wherein the disposable component comprises at least a first lockout circuit and a second lockout circuit, wherein the first lockout circuit comprises a first fuse link, wherein the second lockout circuit comprises a second fuse link;
a computing device in communication with the first lockout circuit and the second lockout circuit; and
a computer-readable storage medium in communication with the computing device, wherein the computer-readable storage medium comprises one or more programming instructions for:
deactivating the first fuse link at a first time, and
deactivating the second fuse at a second time, wherein the second time is subsequent to the first time.

12. The fuse system of claim 11, wherein the one or more programming instructions for deactivating the first fuse link comprise one or more programming instructions for deactivating the first fuse link when the medical device is powered on.

13. The fuse system of claim 11, wherein the one or more programming instructions for deactivating the first fuse link comprise one or more programming instructions for deactivating the first fuse link a certain time period after the medical device has been powered on.

14. The fuse system of claim 11, wherein the one or more programming instructions comprise one or more programming instructions for:
in response to deactivation of the first fuse link and the second fuse link, preventing use of the disposable component by the medical device.

15. The fuse system of claim 11, wherein the one or more programming instructions comprise one or more programming instructions for allowing use of the disposable component by the medical device if both the first fuse link and the second fuse link are intact.

16. The fuse system of claim 11, wherein the one or more programming instructions comprise one or more programming instructions for allowing use of the disposable component by the medical device if only the second fuse link is intact.

17. The fuse system of claim 11, wherein the one or more programming instructions comprise one or more programming instructions for:
in response to completion of a procedure utilizing the medical device, deactivating the second fuse link.

18. The fuse system of claim 17, wherein the one or more programming instructions for determining whether a procedure utilizing the hyperthermia apparatus has been completed comprise one or more programming instructions for:
receiving confirmation that the procedure has been completed from a user; and
in response to receiving confirmation, deactivating the second fuse link.

19. The fuse system of claim 11, wherein the one or more programming instructions comprise one or more programming instructions for:
deactivating the second fuse link after a period of time has passed since the medical device was powered on.

20. The fuse system of claim 11, wherein the one or more programming instructions comprise one or more programming instructions for:
deactivating the second fuse link after a period of time has passed since the first fuse was deactivated.

21. The fuse system of claim 11, wherein the one or more programming instructions comprise one or more programming for:
deactivating the second fuse link after a period of time associated with a procedure has elapsed.
